(19) United States
(12) Patent Application Publication
(10) Pub. No.: US 2010/0008338 A1
(43) Pub. Date: Jan. 14, 2010

(54) HIGH TRANSMISSION POWER USING SHARED BLUETOOTH AND WIRELESS LOCAL AREA NETWORK FRONT END MODULE

(75) Inventors: Yossi Tsfati, Rishon Letzion (IL); Ian Sherlock, Dallas, TX (US); Oren E. Eliezer, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/172,377

(22) Filed: Jul. 14, 2008

(51) Int. Cl. H04Q 7/24; H04B 7/00

(52) U.S. Cl. 370/338; 455/41.2

(57) ABSTRACT

A novel and useful system for providing high transmission power using a shared Bluetooth and Wireless Local Area Network (WLAN) front end module (FEM). A single power amplifier in the front end module is shared between the WLAN and Bluetooth radio cores, thus providing a high power transmission option (Bluetooth class 1) for the Bluetooth core. Interface circuitry in the FEM couple either the WLAN TX output or the Bluetooth TX output to the input of the power amplifier and couple the output of the power amplifier to the external antenna. In the receive direction, the interface circuitry steers the antenna input to the respective WLAN or Bluetooth receivers in accordance with one or more control signals. Alternatively, a switch in the WLAN/Bluetooth radio chip functions to switch the Bluetooth TX output to a conventional FEM, thereby allowing the FEM power amplifier to be shared between the WLAN and Bluetooth radio cores.

### FIELD OF THE INVENTION

The present invention relates to the field of data communications and more particularly relates to a system for providing high transmission power using a shared Bluetooth and Wireless Local Area Network (WLAN) front end module (FEM).

### BACKGROUND OF THE INVENTION

Currently, there is huge demand for converged mobile devices which combine data and telephony capabilities. Technological advances such as extremely low power consumption, improvements in form factor, pricing and co-existence technology for 802.11 (WLAN) and Bluetooth are fueling the demand.

Wireless communication devices such as WLAN and Bluetooth devices are generally constrained to operate in a certain frequency band of the electromagnetic spectrum. The use of frequency bands is licensed by government regulatory agencies, for example, the U.S. Federal Communications Commission (FCC) and the European Radio Communications Office. Licensing is necessary in order to prevent interference between multiple broadcasters trying to use the same frequency band in an area.

Regulatory agencies also specify frequency bands for devices that emit radio frequencies, where licensing is not required. Wireless communication devices using these unlicensed frequency bands generally transmit at low power over a small area. The Industrial, Scientific, or Medical equipment (ISM) band is one such frequency band located between 2.4 and 2.5 GHz. This 2.4 GHz band is used by many wireless communication devices for data and/or voice communication networks.

An example of such a network is defined by the Bluetooth specification. Bluetooth specifies communication protocols for low cost, low power wireless devices that operate over a very small area, the so-called, personal area network. These wireless devices may include, for example, telephone headsets, cell phones, Internet access devices, personal digital assistants, laptop computers, etc. The Bluetooth specification effectively replaces cables used to connect communicating devices, for example, a cell phone and a headset, with a wireless radio link to provide greater ease of use by reducing the tangle of wires frequently associated with personal communication systems. Several such personal communication devices may be wirelessly linked together by using the Bluetooth specification, which derives its name from Harald Blatand (Blatand is Danish for Bluetooth), a 10^{th} century Viking king who united Denmark and Norway.

Bluetooth is an industrial specification for wireless personal area networks (PANs). Bluetooth provides a way to connect and exchange information between devices such as mobile phones, printers, PCs, laptops, and other digital equipment, over a secure, globally unlicensed short-range radio frequency (RF).

Bluetooth is a radio standard and communications protocol primarily designed for low power consumption, with a short range based on low-cost transceiver integrated circuits (ICs) in each device. Bluetooth networks enable these devices to communicate with each other when they are in range.

Bluetooth capability is increasingly built-in to many new products such as phones, printers, modems and headsets. Bluetooth is appropriate for situations when two or more devices are in proximity to each other and do not require high bandwidth. Bluetooth is most commonly used with phones and hand-held computing devices, either using a Bluetooth headset or transferring files from phones/PDAs to computers.

Bluetooth also simplified the discovery and setup of services, in contrast to WLAN which is more analogous to a traditional Ethernet network and requires configuration to set up shared resources, transmit files, set up audio links (e.g., headsets and hands-free devices), whereas Bluetooth devices advertise all the services they provide; thus making the service more accessible, without the need to worry about network addresses, permissions, etc.

Because devices operate in the unlicensed 2.4 GHz RF band, they are subject to radio interference from other wireless devices operating in the same frequency band. To avoid RF interference, the Bluetooth specification divides the 2.4 to 2.5 GHz frequency band into 1 MHz-spaced channels. Each channel signals data packets at 1 Mb/s, using a Gaussian Frequency Shift Keying modulation scheme, in a basic modulation scheme referred to as “Bluetooth Basic rate”, or 2 Mbps or 3 Mbps using pi/4DQPSK and 8DPSK in a modulation scheme referred to as enhanced data rate (EDR).

A Bluetooth device transmits a modulated data packet to another Bluetooth device for reception. After a data packet is transmitted and received, both devices retune their radio to a different 1 MHz channel, effectively hopping from radio channel to radio channel, i.e., frequency-hopping spread spectrum (FHSS) modulation, within the 2.4 to 2.5 GHz frequency band. In this way, Bluetooth devices use most of the available 2.4 to 2.5 GHz frequency band and if a particular signal packet transmission/reception is compromised by interference on one channel, a subsequent retransmission of the particular signal packet on a different channel is likely to be effective.

Bluetooth devices operate in one of two modes: as a Master device or a Slave device. The Master device provides a network clock and determines the frequency hopping sequence. One or more Slave devices synchronize to the Master's clock and follow the Master's hopping frequency.

Bluetooth is a time division multiplexed system, where the basic unit of operation is a time slot of 625 microsecond duration. The Master device first transmits to the Slave device during a first time slot of 625 microseconds with both devices tuned to the same RF channel. Thus, the Master device transmits and the Slave device receives during the first time slot. Following the first time slot, the two devices retune their radios, or hop, to the next channel in the frequency hopping sequence for the second time slot. During the second time slot, the Slave device must respond whether it successfully understood, or not, the last packet transmitted by the Master during the first time slot. The Slave device thus transmits and the Master device receives during the second time slot. As a Slave device must respond to a Master's transmission, communication between the two devices requires at a minimum two time slots or 1.25 milliseconds.

Data packets, when transmitted over networks, are frequently susceptible to delays by, for example, retransmissions of packets caused by errors, sequence disorders caused by alternative transmission pathways, etc. Packet delays do not cause much of a problem with the transmission of digital data because the digital data may be retransmitted or re-sequenced by the receiver without effecting the operation of computer programs using the digital data. Packet delays or dropped packets during the transmission of voice signals, however, can cause unacceptable quality of service.

The Bluetooth specification version 1.0 and above provides a Synchronous Connection Oriented (SCO) link for voice packets that is a symmetric link between Master and Slave devices with periodic exchange of voice packets during reserved time slots. The Master device transmits SCO packets to the Slave device at regular intervals, defined as the SCO interval or T_{SCO}, which is counted in time slots. Bandwidth limitations limit the Bluetooth specification to a maximum of three SCO links. Therefore, the widest possible spacing for an SCO pair of time slots, which are sometimes called a voice slot, is every third voice slot. Bluetooth specification version 1.2 provides enhanced SCO links, i.e. eSCO links, which have a larger voice slot size, based on N*625 microsecond time slots, with larger and configurable intervals between voice slots. These eSCO links can be used for both voice or data applications.

The Institute of Electronic and Electrical Engineer (IEEE) 802.11 specification for Wireless Local Area Networks (WLANs) is also a widely used specification that defines a method of RF modulation, i.e. direct sequence spread spectrum (DSSS) and/or high-rate direct sequence spread spectrum (HR/DSSS), and/or Orthogonal Frequency Division Modulation (OFDM) which also uses the same 2.4 GHz RF band as Bluetooth devices. Radio interference occurs when Bluetooth and WLAN devices try to communicate simultaneously over the same RF band.

Direct-sequence modulation is a spread spectrum technique used to transmit a data packet over a wide frequency band. The RF energy is spread over a wide band in a mathematically controlled way. Changes in the radio carrier are present across a wide band and receivers perform correlation processes to look for changes. Correlation provides DSSS and HR/DSSS transmissions excellent protection against radio interference because noise tends to take the form of relatively narrow pulses that do not produce coherent effects across the entire frequency band. Hence, the correlation function spreads out the noise across the band, while the correlated signal shows a much greater signal amplitude. Direct-sequence modulation trades bandwidth for throughput.

WLANs can operate as independent networks, in which stations, e.g., laptop computers, communicate directly with each other, or as infrastructure networks that comprise stations, which are radio linked to a wired backbone network, e.g., Ethernet, by an access point. An access point that is associated with one or more stations forms an infrastructure service set, which provides network services to an infrastructure basic service area. All communication between stations in an infrastructure service set must go through an access point. Each station, at any point in time, is only associated with one access point. If a station, i.e. the source, in an infrastructure service set needs to communicate with another station, i.e. the destination, the source station first transmits by radio a data packet to its access point. The access point receives the radio transmission and then transmits the data packet to the destination station.

Several access points can be linked to a wired backbone network to form an extended service set comprising multiple infrastructure service sets and forming a corresponding extended service area. Access points are typically located along the wired backbone network forming overlapping infrastructure service areas, allowing for movement of a station from one infrastructure service area to another infrastructure service area without loss of communication between other stations of the extended service set.

Access points, which derive their power from the wired backbone network, assist stations, which are typically battery-powered, to save power. Access points remember when a station enters a power-saving mode, i.e. a sleep state, and buffer packets directed to the sleeping station. Battery-powered stations can therefore turn their wireless transceiver off and power up only to transmit and retrieve buffered data packets from the access point. The mobile station power saving mode is one of the most important features offered by an infrastructure network.

WLANs manage the communication of information from stations to a network in order for stations in search of connectivity to locate a compatible wireless network, to authenticate a mobile station for connection to a particular wireless network and to associate a mobile station with a particular access point to gain access to the wired backbone network. These management communications are defined under the WLAN specification by the Media Access Control (MAC). The MAC includes a large number of management frames that communicate network management functions, e.g., a Request for Association from a station to an access point, in an infrastructure network.

A station locates an existing WLAN network by either passive scanning or active scanning. Passive scanning saves battery power because it does not require transmitting. The station awakens from a sleep mode and listens or scans for a Beacon management frame, which broadcasts the parameters and capabilities of an infrastructure network from an access point. From the traffic indication map of the Beacon frame, the station determines if an access point has buffered traffic on its behalf. To retrieve buffered frames, the station uses a Power Save (PS)-Poll control frame. Active scanning requires that the station actively transmit a Probe Request frame to solicit a response from an infrastructure network with a given name and of known parameters and capabilities. After determining that a responding network of a given name and of known parameters and capabilities is present, the station sequentially joins, authenticates and requests an association with the responding network by transmitting an Association Request management frame. After receipt of the Association Request frame, an access point responds to the station with an Association Response management frame and the station now has access to the wired backbone network and its associated extended service area.

Management frames, such as an Association Request from a station, or an Association Response, a Beacon and a Probe Response from an access point, include a MAC header, a frame body containing information elements and fixed fields and a frame check sequence. Information elements are variable-length components of management frames that contain information about the parameters and capabilities of the network's operations. A generic information element has an ID number, a length, and a variable-length component. Element ID numbers are defined by IEEE standards for some of the 256 available values, other values are reserved. The value 221 is used for vendor specific extensions and is used extensively in the industry.

A block diagram illustrating an example prior art Bluetooth piconet and Wireless Local Area Network (WLAN) is shown in FIG. 1. The Bluetooth piconet, generally referenced 10, comprises a Bluetooth device 14 that acts as the master and a plurality of salve devices 12. The WLAN, generally referenced 16, comprises a WLAN access point 17, coupled to a plurality of WLAN devices 18. Note that some of the WLAN and Bluetooth devices may be co-located as shown, for example, in dashed box 13.

As Bluetooth personal area networks and WLANs use the same ISM RF band of 2.4 GHz to 2.5 GHz, radio interference between the different devices can degrade network communications, e.g., decreased data throughput and quality of voice service caused by retransmissions resulting from interference.

In addition, wireless device manufacturers are increasingly incorporating WLAN and Bluetooth radios in their products. Single chip solutions are available that incorporate WLAN, Bluetooth and FM radio in a single package. This provides the benefits of reduced power consumption, reduces bill of materials and provides for a small form factor. It also permits coexistence features to enable simultaneous operation of each integrated function.

Currently, in some applications, each radio on the single chip interfaces to a respective front end module (FEM) and respective antenna, which functions to provide the interface to an antenna and to amplify an input TX signal for transmission. To reduce cost, improve power consumption and reduce size, it would be more efficient to have a single FEM that is capable of interfacing both the WLAN and Bluetooth radios to a single antenna wherein the power amplifier and interface circuitry is shared among both radios.

### SUMMARY OF THE INVENTION

The present invention is a novel and useful system for providing high transmission power using a shared Bluetooth and Wireless Local Area Network (WLAN) front end module (FEM). The shared FEM mechanism of the present invention functions to provide a high power transmission option (Bluetooth class 1) for the Bluetooth core.

In operation, a single power amplifier in the front end module is shared between the WLAN and Bluetooth radio cores. In accordance with one or more control signals, interface circuitry in the FEM comprising one or more switches couple either the WLAN TX output or the Bluetooth TX output to the input of the power amplifier and also couple the output of the power amplifier to the external antenna. In the receive direction, the interface circuitry steers the antenna input to the respective WLAN or Bluetooth receivers in accordance with one or more control signals.

The shared FEM mechanism of the invention provides several advantages, including: (1) the ability to provide class 1 emission levels to the Bluetooth core without requiring a separate FEM (i.e. the power amplifier for WLAN transmission already supports this); (2) the ability to bypass the shared power amplifier for low power Bluetooth transmission purposes; (3) the ability to use a conventional FEM in the case the switching control is incorporated in the radio module; (4) the reduction in cost, power consumption, PCB real estate required and bill of materials (BOM) achieved by sharing the single power amplifier in the FEM between both WLAN and Bluetooth radios.

Although the mechanism of the present invention can be used in numerous types of communication systems, to aid in illustrating the principles of the present invention, the description of the shared FEM mechanism is provided in the context of a Bluetooth/WLAN radio enabled communication device such as a cellular phone.

Although the coexistence mechanism of the present invention can be incorporated in numerous types of Bluetooth/WLAN enabled communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the present invention, a radio frequency (RF) front end module (FEM) for use with a first radio and a second radio comprising a power amplifier operative to amplify a transmit signal for transmission over an external antenna and interface circuitry operative to electrically couple the transmit signal from either a first radio or a second radio to the input of the power amplifier such that the power amplifier is shared between the first radio and the second radio.

There is also provided in accordance with the present invention, a high power radio frequency (RF) transmission system comprising an RF front end module (FEM) comprising a power amplifier operative to amplify a TX input signal for transmission over an external antenna, the power amplifier adapted to be shared by a plurality of radios, a radio module comprising a first radio core comprising a first transmit path operative to be electrically coupled to the TX input of the FEM, a second radio core comprising a second transmit path and a first switch operative to electrically couple the second transmit path to the first transmit path in accordance with a control signal, thereby electrically coupling the second transmit path to the TX input of the FEM and wherein the first radio core and the second radio core share access to the power amplifier within the FEM.

There is further provided in accordance with the present invention, a method of high power wireless local area network (WLAN) and Bluetooth transmission, the method comprising the steps of providing a front end module (FEM) comprising a single power amplifier, providing a first TX path from a WLAN core to the power amplifier, providing a second TX path from a Bluetooth core to the power amplifier, first switching between the first TX path and the second TX path, in accordance with a first control signal, such that the power amplifier is shared by the WLAN core and the Bluetooth core and coupling the output of the power amplifier to an external antenna.

There is also provided in accordance with the present invention, a communications device comprising a wireless local area network (WLAN) radio, a Bluetooth radio, a front end module, comprising, a power amplifier operative to amplify a transmit signal for transmission over an external antenna coupled to the FEM and coupling circuitry operative to electrically couple the transmit signal from either the WLAN radio or the Bluetooth radio to the input of the power amplifier such that the power amplifier is shared between the WLAN radio and the Bluetooth radio.

### BRIEF DESCRIPTION OF THE DRAWINGS

The invention is herein described, by way of example only, with reference to the accompanying drawings, wherein:

FIG. 1 is a block diagram illustrating an example prior art Bluetooth piconet and Wireless Local Area Network (WLAN);

FIG. 2 is a block diagram illustrating a first example WLAN/Bluetooth high power transmission scheme;

FIG. 3 is a block diagram illustrating a second example WLAN/Bluetooth high power transmission scheme;

FIG. 4 is a flow diagram illustrating the WLAN TX FEM method;

FIG. 5 is a flow diagram illustrating the WLAN RX FEM method;

FIG. 6 is a flow diagram illustrating the Bluetooth TX FEM method;

FIG. 7 is a flow diagram illustrating the Bluetooth RX FEM method;

FIG. 8 is a block diagram illustrating a third example WLAN/Bluetooth high power transmission scheme;

FIG. 9 is a flow diagram illustrating the Bluetooth regular transmission method;

FIG. 10 is a flow diagram illustrating the Bluetooth high power transmission method;

FIG. 11 is a block diagram illustrating the coexistence system including the packet traffic arbitration (PTA) machine of the present invention;

FIG. 12 is a flow diagram illustrating the overall coexistence method of the present invention;

FIG. 13 is a flow diagram illustrating the Bluetooth detection and prediction method of the present invention;

FIG. 14 is a flow diagram illustrating the Bluetooth prediction method of the present invention for terminating a Bluetooth high priority active period;

FIG. 15 is a flow diagram illustrating the PTA common mode method of the present invention;

FIG. 16 is a diagram illustrating the PTA queue in more detail;

FIG. 17 is a timing diagram illustrating WLAN system timing utilzing unused Bluetooth bandwidth;

FIG. 18 is a flow diagram illustrating the PTA protective mode method of the present invention; and

FIG. 19 is a simplified block diagram illustrating an example mobile handset incorporating the Bluetooth/WLAN high power transmission scheme of the present invention.

### DETAILED DESCRIPTION OF THE INVENTION

### Notation Used Throughout

The following notation is used throughout this document.

| Term | Definition |
|---|---|
| AC | Alternating Current |
| AHF | Adaptive High Frequency |
| AP | Access Point |
| APSD | Automatic Power Save Delivery |
| ASIC | Application Specific Integrated Circuit |
| ATIM | Announcement Traffic Indication Message |
| AVI | Audio Video Interleave |
| BMP | Windows Bitmap |
| BOM | Bill of Materials |
| BPF | Band Pass Filter |
| BSS | Basic Service Set |
| BT | Bluetooth |
| CCA | Clear Channel Assessment |
| CPU | Central Processing Unit |
| CW | Contention Window |
| DC | Direct Current |
| DPA | Digitally Controlled Power Amplifier |
| DPSK | Differential Phase Shift Keying |
| DQPSK | Differential Quadrature Phase Shift Keying |
| DSP | Digital Signal Processor |
| DSSS | Direct Sequence Spread Spectrum |
| DTIM | Delivery Traffic Indication Message |
| EDR | Enhanced Data Rate |
| EEPROM | Electrically Erasable Programmable Read Only Memory |
| ELP | Encoded Level Point |
| EPROM | Erasable Programmable Read Only Memory |
| ESS | Extended Service Set |
| FCC | Federal Communications Commission |
| FCS | Frame Check Sequence |
| FE | Front End |
| FEM | Front End Module |
| FHSS | Frequency Hopping Spread Spectrum |
| FM | Frequency Modulation |
| FPGA | Field Programmable Gate Array |
| GPS | Ground Positioning Satellite |
| HDL | Hardware Description Language |
| HP | High Priority |
| HR | High Rate |
| I/F | Interface |
| IBSS | Independent Basic Service Set |
| IC | Integrated Circuit |
| ID | Identification |
| IE | Information Element |
| IEEE | Institute of Electrical and Electronics Engineers |
| IP | Internet Protocol |
| ISM | Industrial, Scientific, Medical |
| JPG | Joint Photographic Experts Group |
| LAN | Local Area Network |
| LNA | Low Noise Amplifier |
| MAC | Media Access Control |
| MAC | Media Access Control |
| MBOA | Multiband OFDM Alliance |
| MP3 | MPEG-1 Audio Layer 3 |
| MPDU | MAC Protocol Data Unit |
| MPG | Moving Picture Experts Group |
| MSDU | MAC Service Data Unit |
| MSDU | MAC Service Data Unit |
| NIC | Network Interface Card |
| OFDM | Orthogonal Frequency Division Multiplexing |
| PAN | Personal Area Network |
| PC | Personal Computer |
| PCB | Printed Circuit Board |
| PCI | Personal Computer Interconnect |
| PDA | Portable Digital Assistant |
| PER | Packet Error Rate |
| PLCP | Physical Layer Conversion Protocol |
| PPA | Pre-Power Amplifier |
| PRM | Prediction Machine |
| PS | Power Save |
| PTA | Packet Traffic Arbitration |
| RAM | Random Access Memory |
| RF | Radio Frequency |
| ROM | Read Only Memory |
| SCO | Synchronous Connection Oriented |
| SIFS | Short Inter-Frame Space |
| SIM | Subscriber Identity Module |
| SSID | Service Set Identifier |
| STA | Station |
| TBTT | Target Beacon Transmit Time |
| TIM | Traffic Indication Map |
| TSF | Time Synchronization Function |
| TU | Time Unit |
| TV | Television |
| USB | Universal Serial Bus |
| UWB | Ultra Wideband |
| WiFi | Wireless Fidelity |
| WiMax | Worldwide Interoperability for Microwave Access |
| WiMedia | Radio platform for UWB |
| WLAN | Wireless Local Area Network |
| WMA | Windows Media Audio |
| WMV | Windows Media Video |

### DETAILED DESCRIPTION OF THE INVENTION

The present invention is a novel and useful system for providing high transmission power using a shared Bluetooth and Wireless Local Area Network (WLAN) front end module (FEM). The shared FEM mechanism of the present invention functions to provide a high power transmission option (Bluetooth class 1) for the Bluetooth core.

In operation, a single power amplifier in the front end module is shared between the WLAN and Bluetooth radio cores. In accordance with one or more control signals, interface circuitry in the FEM comprising one or more switches couple either the WLAN TX output or the Bluetooth TX output to the input of the power amplifier and also couple the output of the power amplifier to the external antenna. In the receive direction, the interface circuitry steers the antenna input to the respective WLAN or Bluetooth receivers in accordance with one or more control signals.

Although the mechanism of the present invention can be used in numerous types of communication systems, to aid in illustrating the principles of the present invention, the description of the coexistence mechanism is provided in the context of a Bluetooth/WLAN radio enabled communication device such as a cellular phone.

Although the coexistence mechanism of the present invention can be incorporated in numerous types of Bluetooth/WLAN enabled communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMAX, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### First Embodiment with Duplicate Power Amplifiers

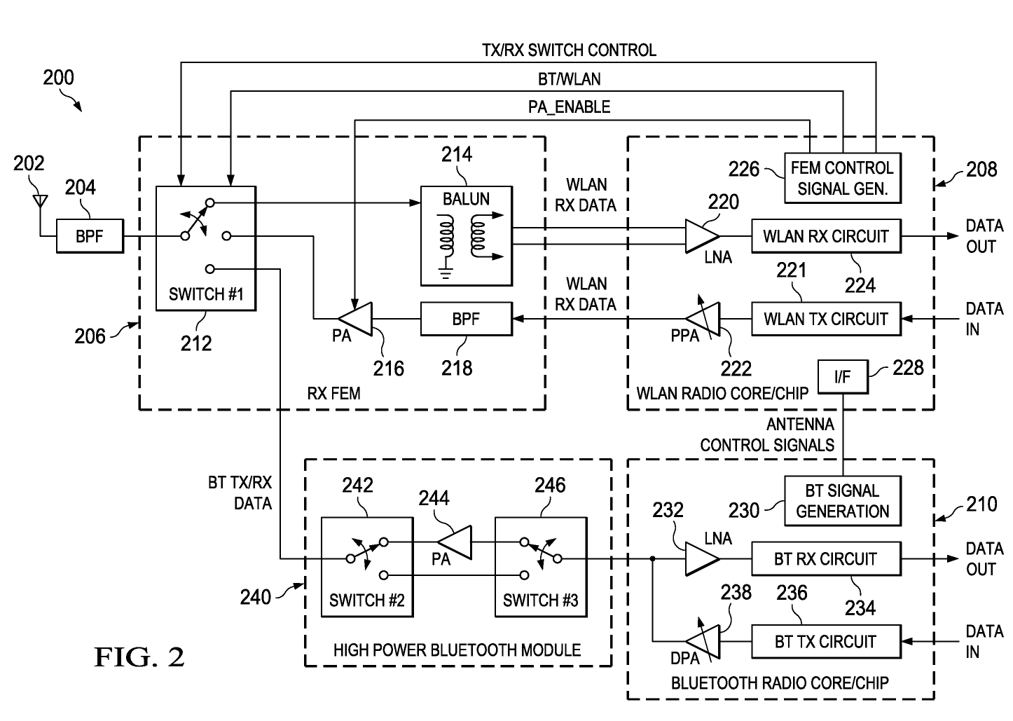

A block diagram illustrating a first example WLAN/Bluetooth high power transmission scheme is shown in FIG. 2. The system, generally referenced 200, comprises a WLAN radio core/chip 208, Bluetooth radio core/chip 210, RF FEM 206, external high power Bluetooth module 240, band pass filter (BPF) 204 and antenna 202. The WLAN radio core comprises, in a receive path, LNA 220 which receives the WLAN RX data signal and WLAN RX circuit 224 which generates the data out signal, and in a transmit path, comprises WLAN TX circuit 221 receiving a data in signal and pre-power amplifier (PPA) 222 which generates the WLAN TX data signal. The WLAN radio core also comprises an interface block 228 for sending/receiving one or more signals to/from the Bluetooth signal generation block 230, and FEM control signal generator 226 which functions to generate the appropriate FEM control signals, namely TX/RX switch control, BT/WLAN and PA_ENABLE.

The Bluetooth radio core comprises, in a receive path, LNA 232 and Bluetooth RX circuit 234 which generates the data out signal, and comprises, in the transmit direction, Bluetooth TX circuit 236, which receives the data in signal, and a pre-power amplifier (PPA) that could be implemented as a Digitally Controlled Power Amplifier (DPA) or as a variable gain control amplifier (VGA) 238. Note that for the sake of simplicity, the Bluetooth internal power amplifier is referred to in this document as the DPA. Note, however, that the DPA may be referred to as the internal Bluetooth PPA as well (which may be implemented as a VGA). The Bluetooth radio core also comprises Bluetooth signal generation block 230 which functions to generate and receive one or more signals for performing coexistence with the WLAN radio core as both radios share a single antenna and thus, their operation must be coordinated.

For low power Bluetooth transmission, the output generated by the DPA is sufficient and can be coupled to the antenna without further amplification. For high power transmission, however, a separate power amplifier is needed. This is provided by the high power Bluetooth module 240, which comprises two switches, switch #2 242 and switch #3 246 and power amplifier 244, which is capable of providing Bluetooth class 1 power levels. Switches #2 and #3 are configured by appropriate control signals to either pass the output of the DPA 238 through the power amplifier 244 or to bypass the power amplifier and couple the DPA directly to the antenna via the FEM 206.

The FEM 206, comprises switch #1 212 (controlled by the TX/RX switch control and BT/WLAN signals) which functions to couple the antenna 202 to either (1) the WLAN RX input via balun 214, (2) the WLAN TX output via BPF 218 and power amplifier 216 (controlled by the BT_ENABLE signal), or (3) the Bluetooth TX/RX data signal from the high power Bluetooth module 240.

In this system 200, where a single antenna is shared between the Bluetooth and WLAN radios, a single FEM is shared between both radios. In this case, however, the power amplifier located in the FEM is directly connected only to the output of the WLAN transmitter of the single-chip hence not allowing high power to be transmitted out of the FEM when the Bluetooth is transmitting. Thus, necessitating use of the separate power amplifier for Bluetooth purposes only.

A disadvantage, however, is that a separate power amplifier is required for high power Bluetooth transmissions. Thus, the power amplifier and its associated circuitry is duplicated which is inefficient in terms of power consumption, cost and size. A more efficient system can be achieved by sharing a single power amplifier as described in a second embodiment hereinbelow.

### Second Embodiment with Shared Power Amplifier

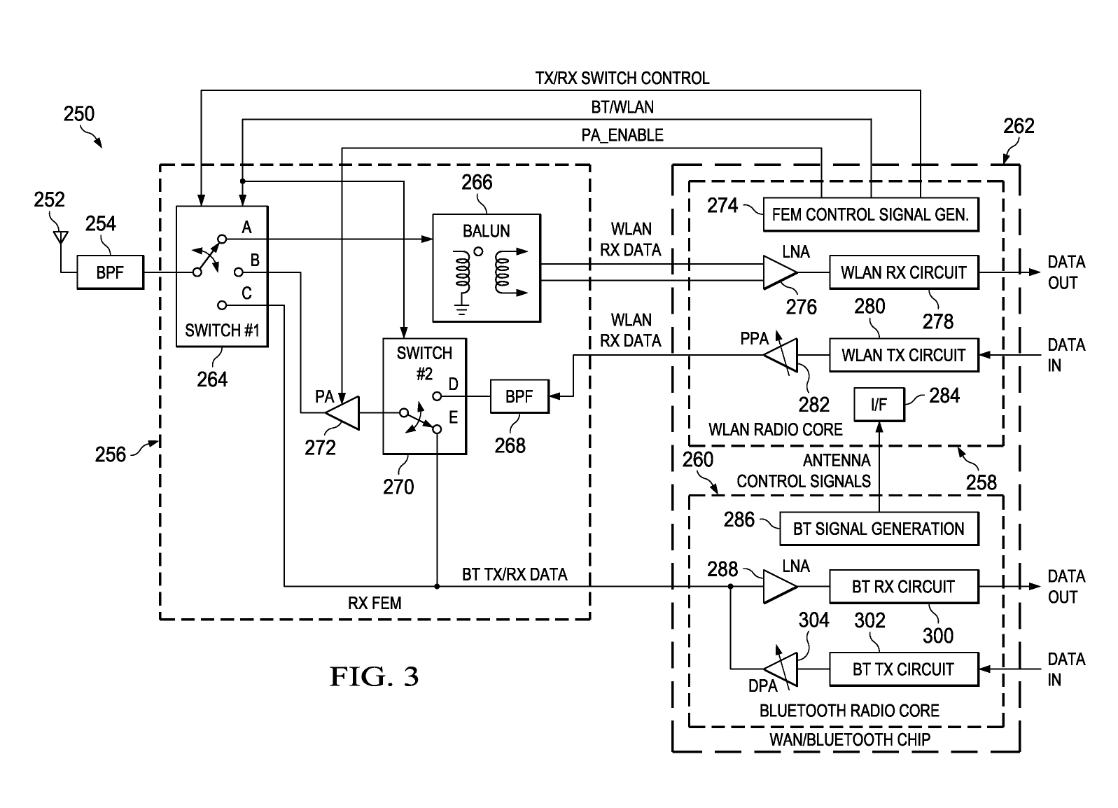

A block diagram illustrating a second example WLAN/Bluetooth high power transmission scheme is shown in FIG. 3. The system, generally referenced 250, comprises a WLAN/Bluetooth chip 262, incorporating a WLAN radio core 258 and a Bluetooth radio core 260, an RF FEM 256, band pass filter (BPF) 254 and antenna 252. The WLAN radio core comprises, in a receive path, LNA 276 which receives the WLAN RX data signal and WLAN RX circuit 278 which generates the data out signal, and in a transmit path, comprises WLAN TX circuit 280 receiving a data in signal and pre-power amplifier (PPA) 282 which generates the WLAN TX data signal. The WLAN radio core also comprises an interface block 284 for sending/receiving one or more signals to/from the Bluetooth signal generation block 286, and FEM control signal generator 274 which functions to generate the appropriate FEM control signals, namely TX/RX switch control, BT/WLAN and PA_ENABLE.

The Bluetooth radio core comprises, in a receive path, LNA 288 and Bluetooth RX circuit 2300 which generates the data out signal, and comprises, in the transmit direction, Bluetooth TX circuit 302, which receives the data in signal, and Digitally Controlled Power Amplifier (DPA) 304. The Bluetooth radio core also comprises Bluetooth signal generation block 230 which functions to generate and receive one or more signals for performing coexistence with the WLAN radio core as both radios share a single antenna and thus, their operation must be coordinated.

The RF FEM 256, comprises switch #1 264 (controlled by the TX/RX switch control and BT/WLAN signals) which functions to couple the antenna 202 to either (1) the WLAN RX input via balun 266 (switch contact A), (2) the power amplifier 272 (controlled by the BT_ENABLE signal) (switch contact B), or (3) the BT TX/RX data signal from the Bluetooth radio core (switch contact C).

In accordance with the invention, the single power amplifier 272 is shared between the WLAN and Bluetooth radio cores. A second switch #2 270 feeds either (1) the WLAN TX data output from the WLAN radio core (via BPF 268) (switch contact D), or (2) the BT TX/RX data signal from the Bluetooth radio core (switch contact E), to the input of the power amplifier.

For low power Bluetooth transmission, the output generated by the DPA is sufficient and can be coupled to the shared antenna 252 without further amplification via switch contact C. For high power transmission, however, the power amplifier is used and switches #1 and #2 are configured (via appropriate control signals) to couple the BT TX/RX data signal to the power amplifier (switch contact E) and subsequently to the antenna (switch contact B).

Thus, in this system 250, both the antenna interface circuitry in the FEM and the power amplifier are shared between the WLAN and Bluetooth radio cores, thereby providing the advantages of reduced cost, bill of materials, power consumption and size. The requirement of a separate power amplifier for Bluetooth class 1 transmissions is thus eliminated.

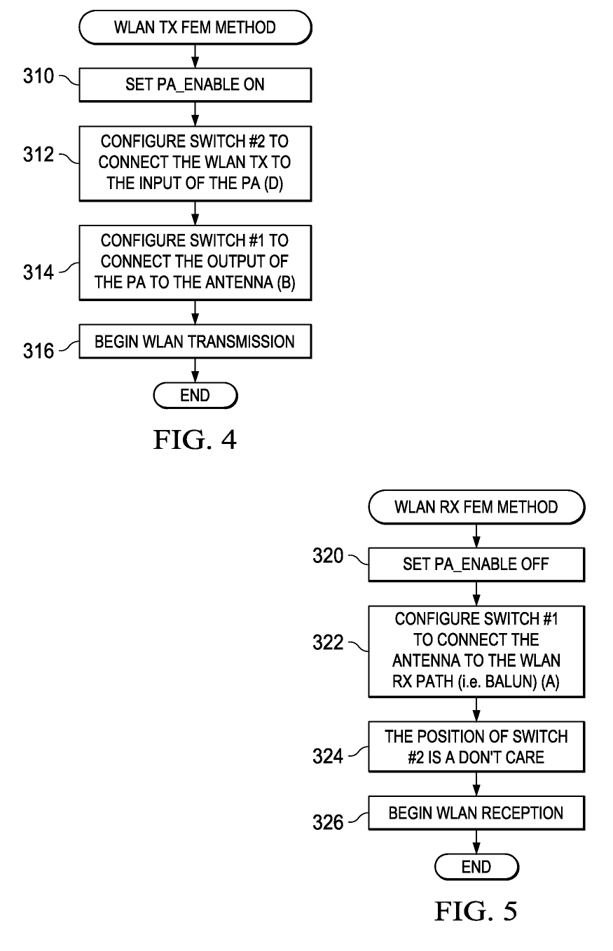

Several methods for configuring switches #1 264 and #2 270 in the FEM 256 for receive and transmit operation for the WLAN and Bluetooth radio cores will now be described. A flow diagram illustrating the WLAN TX FEM method is shown in FIG. 4. The PA_ENABLE signal is set to on to enable the power amplifier 272 on for transmission (step 310). Switch #2 is then configured to couple the WLAN TX data signal to the input of the power amplifier (switch contact D) (step 312). Switch #1 is configured to couple the output of the power amplifier to the external antenna (switch contact B) (step 314). WLAN transimssion can now begin (step 316).

A flow diagram illustrating the WLAN RX FEM method is shown in FIG. 5. The PA_ENABLE signal is set to off to disable the power amplifier 272 (step 320). Switch #1 is configured to couple the antenna to the WLAN RX path via the balum 266 (switch contact A) (step 322). The configuration of switch #2 in this case is not critical (step 324). WLAN reception can now begin (step 326).

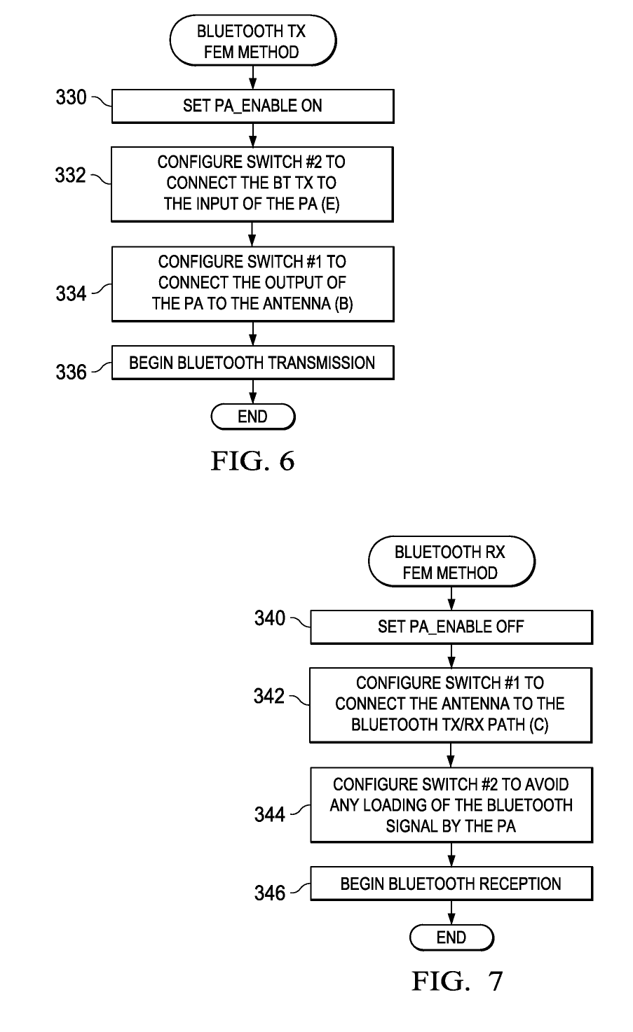

A flow diagram illustrating the Bluetooth TX FEM method is shown in FIG. 6. The PA_ENABLE signal is set to on to enable the power amplifier 272 for transmission (step 330). Switch #2 is then configured to couple the Bluetooth TX/RX data signal to the input of the power amplifier (switch contact E) (step 332). Switch #1 is configured to couple the output of the power amplifier to the external antenna (switch contact B) (step 334). WLAN transimssion can now begin (step 336).

A flow diagram illustrating the Bluetooth RX FEM method is shown in FIG. 7. The PA_ENABLE signal is set to off to disable the power amplifier 272 (step 340). Switch #1 is configured to couple the antenna to the Bleutooth TX/RX data path (switch contact C) (step 342). Switch #2 is configured so as to avoid any loading of the Bluetooth signal by the power amplifier (step 344). Bluetooth reception can now begin (step 346).

### Third Embodiment with Duplicate Power Amplifiers

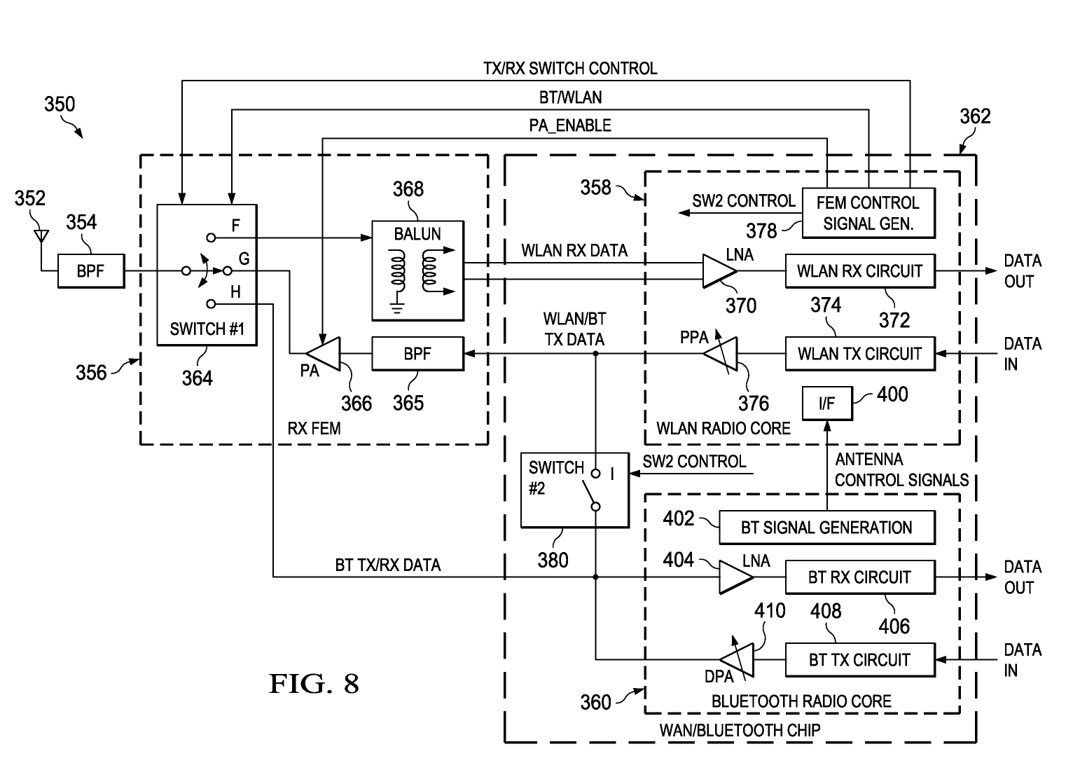

A block diagram illustrating a third example WLAN/Bluetooth high power transmission scheme is shown in FIG. 8. The system, generally referenced 350, comprises an RF FEM 356, band pass filter (BPF) 354, antenna 352 and a WLAN/Bluetooth chip 362 incorporating a WLAN radio core 358, a Bluetooth radio core 360 and switch #2 380,. The WLAN radio core comprises, in a receive path, LNA 370 which receives the WLAN RX data signal and WLAN RX circuit 372 which generates the data out signal, and in a transmit path, comprises WLAN TX circuit 374 receiving a data in signal and pre-power amplifier (PPA) 376 which generates the WLAN TX data signal. The WLAN radio core also comprises an interface block 400 for sending/receiving one or more signals to/from the Bluetooth signal generation block 402, and FEM control signal generator 378 which functions to generate the switch #2 control signal and the appropriate FEM control signals, namely TX/RX switch control, BT/WLAN and PA_ENABLE.

The Bluetooth radio core comprises, in a receive path, LNA 404 and Bluetooth RX circuit 406 which generates the data out signal, and comprises, in the transmit direction, Bluetooth TX circuit 408, which receives the data in signal, and Digitally Controlled Power Amplifier (DPA) 410. The Bluetooth radio core also comprises Bluetooth signal generation block 402 which functions to generate and receive one or more signals for performing coexistence with the WLAN radio core as both radios share a single antenna and thus, their operation must be coordinated.

The RF FEM 356, comprises switch #1 364 (controlled by the TX/RX switch control and BT/WLAN signals) which functions to couple the antenna 352 to either (1) the WLAN RX input via balun 368 (switch contact F), (2) the TX output of the WLAN/Bluetooth chip 362 via BPF 365 and power amplifier 366 (controlled by the BT_ENABLE signal) (switch contact G), or (3) the Bluetooth TX/RX data signal from the Bluetooth radio core 360 (switch contact H).

For low power Bluetooth transmission, the output generated by the DPA 410 is sufficient and can be coupled to the antenna without further amplification via switch #1 (switch contact H). For high power transmission, however, the shared power amplifier 366 in the FEM 356 is used, which is capable of providing Bluetooth class 1 power levels. Rather than switch the WLAN and Bluetooth TX output signals in the FEM, a switch #2 380 in the WLAN/Bluetooth chip 362 functions to switch the Bluetooth TX signal to the output (WLAN/BT TX output) of the chip (switch contact I). Thus, the single transmit path (which includes the power amplifier) in the FEM is shared between the WLAN and Bluetooth TX circuits. Switch #2 is controlled by switch #2 control signal generated by the FEM control signal generator block 378. This permits the use of a conventional RF FEM such as one normally used for WLAN use only.

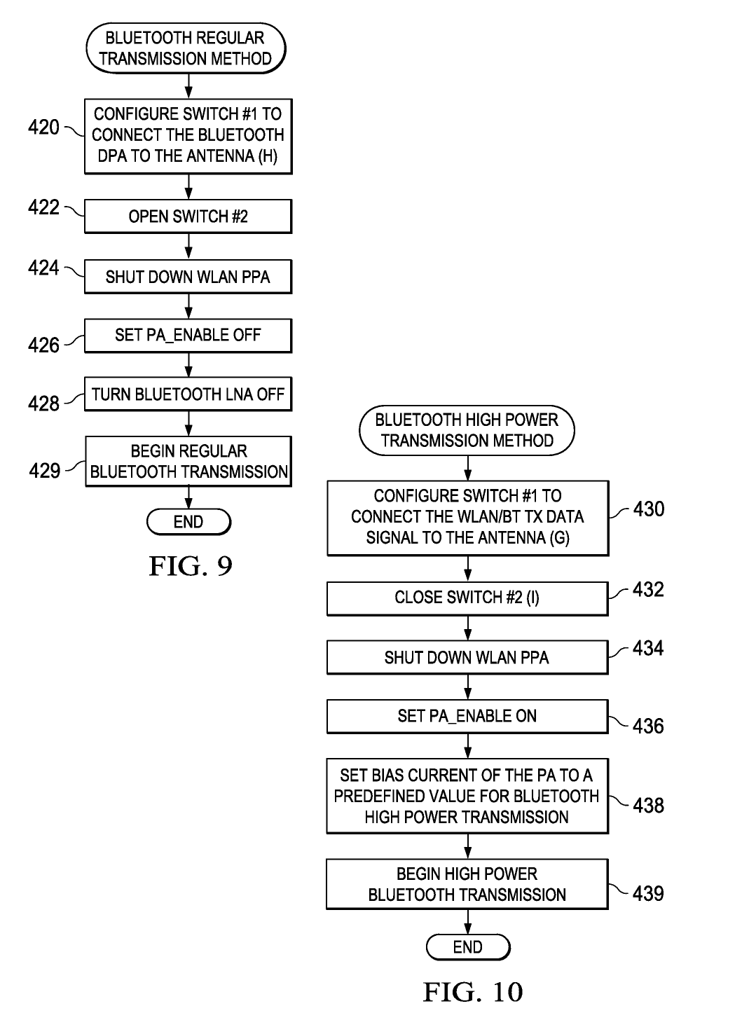

A flow diagram illustrating the Bluetooth regular transmission method is shown in FIG. 9. This configuration is used for regular lower power Bluetooth transmission (i.e. non-class 1 transmission). Switch #1 is configured to couple the Bluetooth DPA 410 to the antenna (switch contact H) (step 420). Switch #1 is opened (step 422) and the WLAN PPA 376 is turned off (step 424). The PA_ENABLE signal is set to off to disable the FEM power amplifier (step 426) and the bluetooth LNA 404 is turned off (step 428). Regular Bluetooth tranmsission can then begin (step 429).

A flow diagram illustrating the Bluetooth high power transmission method is shown in FIG. 10. This configuration is used for high power Bluetooth transmission (i.e. class 1 transmission). Switch #1 is configured to couple WLAN/BT TX data signal to the shared power amplifier 366 via the BPF 365 (switch contact G) (step 430). Switch #2 is closed to couple the output of the Bluetooth DPA 410 to the TX output of the WLAN/Bluetooth chip 362 (step 432). The WLAN PPA 376 is turned off (step 434). The PA_ENABLE signal is set to on to enable the FEM power amplifier (step 436). The bias current of the power amplifier is set to a predefined level suitable for Bluetooth high power transmission (step 438). High power Bluetooth tranmsission can then begin (step 439).

### WLAN/Bluetooth Coexistence: Packet Traffic Arbitration (PTA) and the Bluetooth Prediction Machine (PRM)

Since, in accordance with the invention, the high power PA in the FEM is shared between the WLAN and Bluetooth cores, some type of coexistence scheme is typically used to arbitrate access between the two radios. An example coexistence scheme is described hereinbelow. A more detailed description is provided in U.S. application Ser. No. 11/944,505, filed Nov. 23, 2007, entitled “Apparatus For And Method Of Bluetooth And Wireless Local Area Network Coexistence Using A Single Antenna In A Collocated Device”, incorporated herein by reference in its entirety.

Since the WLAN and Bluetooth systems within the communications device are sharing a single antenna, the probability of packet loss (PER) in both systems increases. This effect can potentially have a fatal influence on the WLAN system side. Missing too many continuous packets sent from the Access Point (AP) will cause the AP to decrease the packet rate. This, in turn, will cause the transmissions to last longer, which decreases the probability of receiving the packet even more. In the worst case, a disconnection occurs. A problematic scenario for the system is when the Bluetooth system activates voice operation which uses very short packet period. Since these short packets contain voice data, they are protected via a protection mode provided by the coexistence mechanism of the present invention.

To address this problem, AP transmissions are scheduled by utilizing Power Save (PS) mode (or APSD in QoS) and CTS-TO-SELF packets. The PS mode is initiated whenever the coexistence algorithm of the invention is enabled. The allocation of bandwidth is based on a packet wise mechanism in accordance with the priority of each packet and a fair partition of the bandwidth.

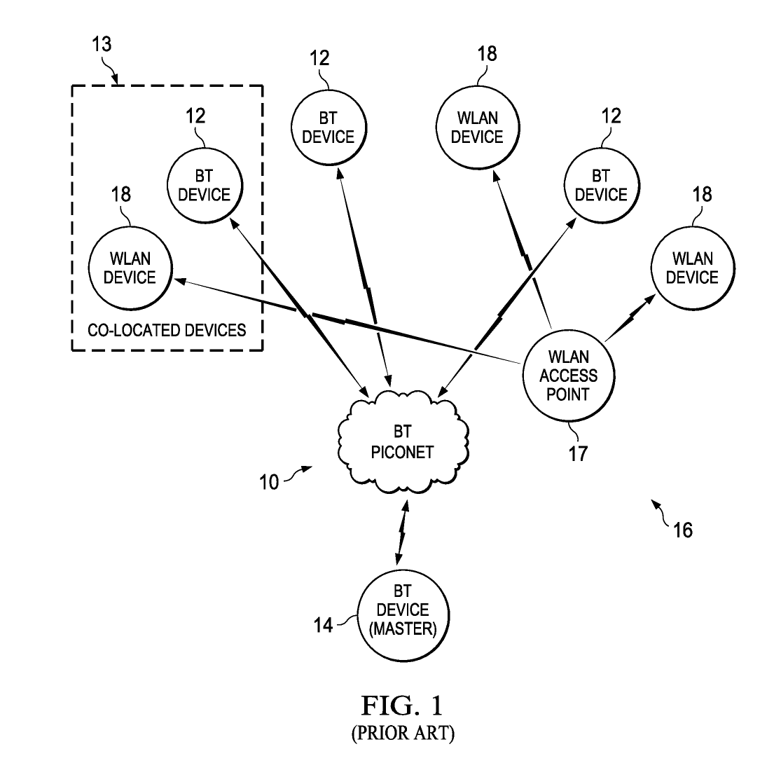

When a Bluetooth high priority (HP) transaction (transmission, packet or frame) is detected on the interface signaling lines (FIG. 1), a Bluetooth Prediction Machine (PRM) (part of a Packet Traffic Arbitration (PTA) module) is used to identify Bluetooth high priority transmission patterns. The operation of the PRM and PTA machines are described in more detail infra. The STA and AP transmissions are scheduled in the available time period between Bluetooth high priority frames. If there no periodic Bluetooth high priority traffic is detected, the WLAN system operates in PS mode, but without the need to schedule WLAN transmissions in such a way that will not harm Bluetooth transmissions.

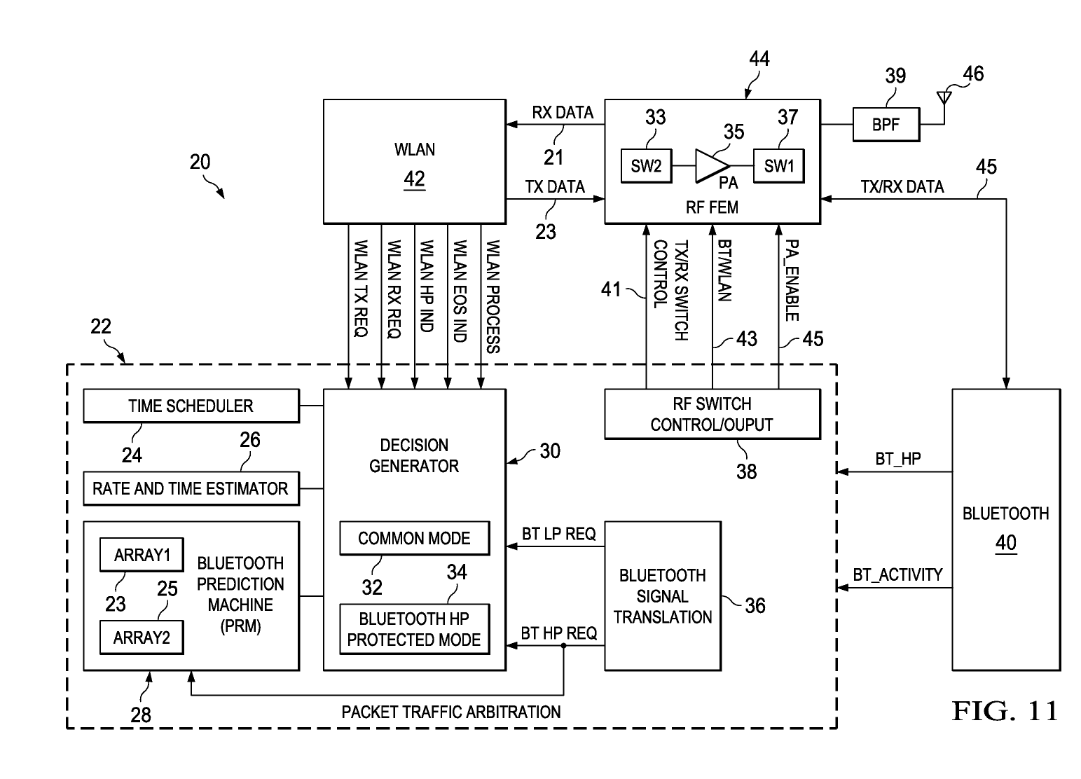

A block diagram illustrating the coexistence system including the packet traffic arbitration (PTA) machine of the present invention is shown in FIG. 11. The coexistence system, generally referenced 20, comprises the PTA 22, WLAN system 42, Bluetooth system 40, RF antenna switch 44 and antenna 46. The PTA 22 comprises a decision generator 30, common mode block 32, Bluetooth high priority protected mode block 34, RF antenna switch control/output block 38, Bluetooth signal translation 36, time scheduler 24, rate and time estimation block 26 and PRM 28.

Utilizing the Bluetooth Prediction Machine (PRM), the decision generator performs four principle functions: (1) trace periodic Bluetooth high priority transmissions; (2) decide whether to enter “Bluetooth high priority protective mode”; (3) identify the termination of periodic Bluetooth high priority transmissions; and (4) synchronize the WLAN system to the Bluetooth frame clock. Note that the PRM is activated whenever the coexistence mechanism is active.

The PRM is operative to identify the following Bluetooth patterns:

1. HV3 packet: cover up to a single time slot. Period=6 Bluetooth slots.

2. EV3 packet: cover up to a single time slot. Period (T_{ESCO})=4 to 6 Bluetooth slots.

3. EV4 packet: cover to up three time slots. Period (T_{ESCO})=8 to 24 Bluetooth slots.

4. EV5 packet: cover up to three time slots. Period (T_{ESCO})=8 to 36 Bluetooth slots.

The default values typically in use are referred to as prioritized periods. These values are likely to be the most common. The values include:

1. HV3 and EV3—6 Bluetooth slots

2. EV4—24 Bluetooth slots

3. EV5—36 Bluetooth slots

The prioritized periods are hard coded. One additional prioritized period will be configured in the WlanPRIPeriods register. The example algorithm presented herein supports periods bigger than the following:

1. EV3 with T_{ESCO}>=6 slots

2. EV4 with T_{ESCO}>=10 slots

3. EV5 with T_{ESCO}>=10 slots

Thus, the PRM attempts to detect only periods of 6 to 40 Bluetooth slots, or in terms of frames, 3 to 20 Bluetooth frames. Note that two consecutive slots of the same transaction (TX+RX or RX+TX) are considered a frame. The PRM operates in frame time units, since it is Bluetooth high priority, and the transactions are synchronized to the master, i.e. 1 frame unit=1.25 milliseconds.

The PRM operates based on the assumption that there are no more than four Bluetooth high priority transactions in parallel (i.e. voice, scan, AFH and sniff), and that non-voice transactions have a significantly longer period than voice transactions.

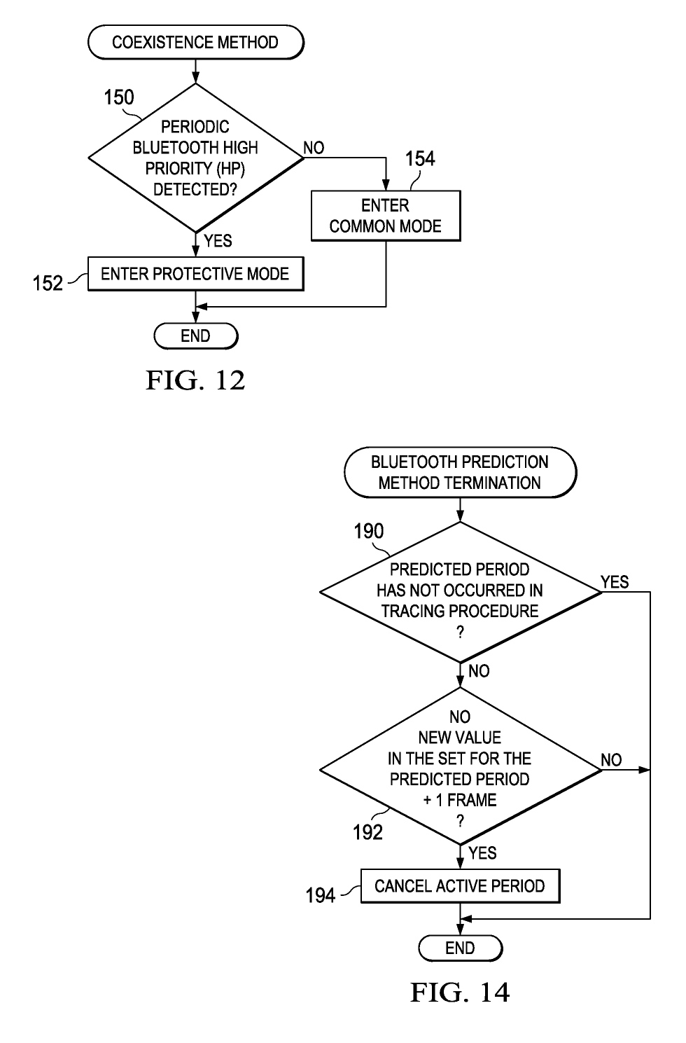

A flow diagram illustrating the overall coexistence method of the present invention is shown in FIG. 12. If a periodic Bluetooth high priority transaction is detected (step 150), the protective mode is entered (step 152). If not, the common mode is entered (step 154).

### Detecting Bluetooth High Priority Periods

The duration is defined as the time a Bluetooth transaction lasted, e.g., a typical HV3 transaction has a duration of 1.25 milliseconds. The period is defined as the time between high priority transactions, e.g., a typical HV3 transaction has a period of 3.75 milliseconds.

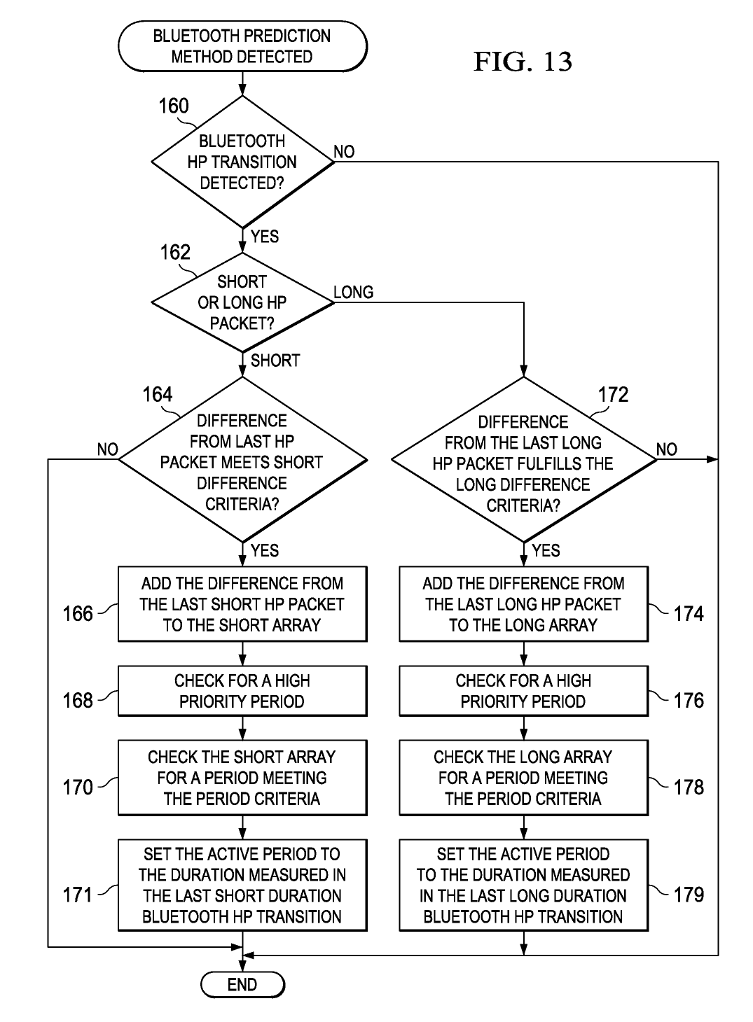

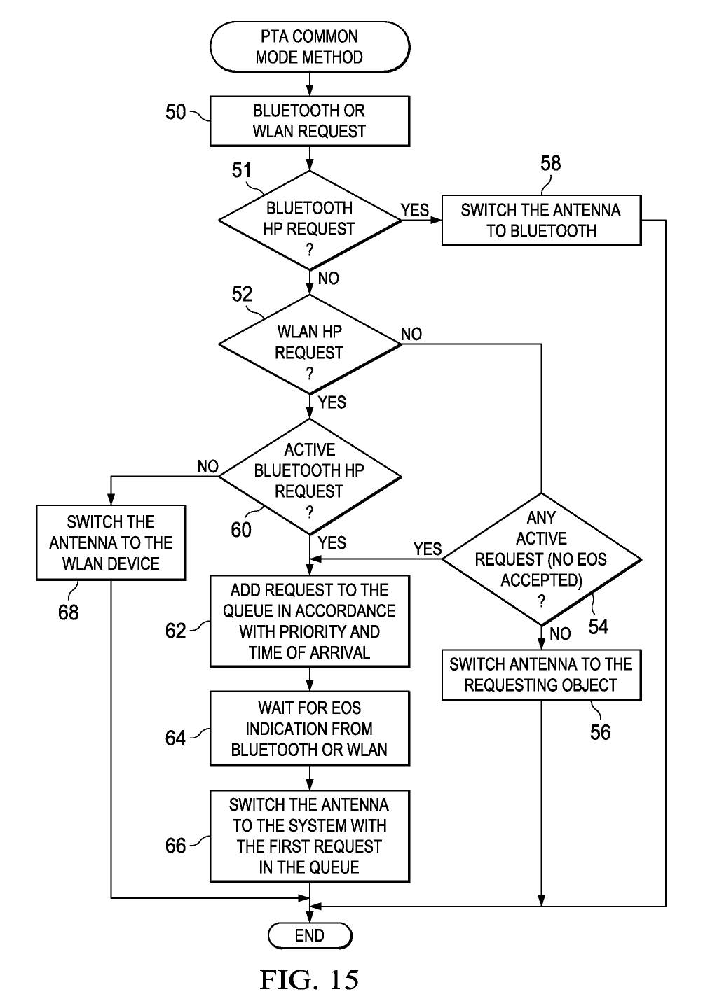

A flow diagram illustrating the Bluetooth detection and prediction method of the present invention is shown in FIG. 13. With reference to FIGS. 13 and 15, the PRM maintains two orthogonal arrays, i.e. sets, which contain the differences between Bluetooth high priority transactions. The first array or short array (array #1 23) stores differences between short duration Bluetooth high priority transactions (the high priority transactions are less than 1.5 frames). The first array can contain up to 6 differences and is referred to as the first array or set size.

The second array or long array (array #1 25) stores differences between long duration Bluetooth high priority transactions (the high priority transactions are more than 1.5 frames but less than 3.1 frames). The second array can contain up to 8 differences and is referred to as the second array or set size.

When a new Bluetooth high priority transaction is detected (step 160), the PRM waits until the end of the transaction. The PRM checks the transaction to whether it is a short duration transaction or a long duration transaction (step 162). If the transaction is a short duration, the PRM determines the differences from the last short high priority packet and whether they meet short difference criteria (step 164). The PRM adds the differences values to the short array if the difference fulfills the following criteria (step 166).

To enter the first array (short duration), the difference must be 3<=difference<=12. A specific difference will not be entered to the first set (short duration): a difference of 4 if previously there were four or more differences of ones (i.e. the pattern 1, 1, 1, 1, 4 or more ones). This is because the long transaction that last 3 frames causes a split between short transactions that make them appear like a difference of 4. For example, a scan that appears in voice traffic as 1, 1, 1, 1, 1, 1, 1 . . . 1, 1, when between EV4 packets looks like 1, 1, 1, 1, 1, 1, 1, 4, 1, 1, 1 . . . .

It is then checked for a high priority period (step 168). The short array is searched for a period meeting the period criteria described below (step 170). If found, the active period is set according to the duration measured in the last short duration Bluetooth high priority transaction (step 171).

If the transaction is a long duration (step 162), the PRM determines the differences from the last long high priority packet and whether they meet long difference criteria (step 172). The PRM adds the differences values to the long array if the difference fulfills the following criteria (step 174).

To enter the second array (long duration), the difference must be 5<=diff<=24. It is then checked for a high priority period (step 176). The long array is searched for a period meeting the period criteria described below (step 178). If found, the active period is set according to the duration measured in the last long duration Bluetooth high priority transaction (step 179).

In this manner, retransmissions are not added to the arrays, and only logical periods according to packet type are counted. Each set will be filled in a cyclic way as follows. If the difference between transactions is bigger than 24 frames, the relevant set (i.e. either short or long) is cleared from all values. Note that if the station was in ELP before the difference was performed, the value of the difference is counted for set clearing.

After a new value is added to an array, a period search in the same array is performed in the following manner. For the short array, if 4 of the differences in the short array have a value identical to one of the prioritized periods, that period is declared as the active period. If 4 of the differences in the short array have the same value, the difference is declared as the active period.

For the long array, if 4 of the differences in the long array have a value identical to one of the prioritized periods, that period is declared as the active period. If 5 of the differences in the long array have the same value, that difference is declared as the active period.

The duration of the high priority transaction (T1-T2) is set according to the duration measured in the last Bluetooth high priority transaction which caused the period to be trigged. The PRM checks the value of the duration each sample of the period and changes the duration transferred to the decision mechanism only if it is bigger than the first one.

The PRM 28 sends the resultant period and duration information to the decision generator 30 as soon as possible. A summary of array parameters are presented below in Table 6.

TABLE 6
Summary of Array Parameters

array

| | First set | Second set |
|---|---|---|
| Parameter | (short duration) | (long duration) |
| Set size | 6 | 8 |
| High priority value | 4 | 4 |
| Low priority value | 4 | 5 |
| Min difference to enter set | 3 | 5 |
| Max difference to enter set | 12 | 24 |

The PRM performs tracing on the active period, and checks if each sample occurred within the predicted time. This tracing is used both for synchronization and termination of the active period. The PRM synchronizes the prediction timing to the Bluetooth frame clock in every sample of the detected period. The PRM does not synchronize the system to high priority packets which are not a part of the period.

A flow diagram illustrating the Bluetooth prediction method of the present invention for terminating a Bluetooth high priority active period is shown in FIG. 14. The PRM cancels (i.e. terminates) an active period in one of the following cases: (1) if the trace procedure finds that a predicted period has not occurred (step 190); or (2) no new value in the array was found for the_predicted_period+1 frames (step 192). Each time the PRM cancels an active period, the relevant array (i.e. short or long) is cleared from all values.

If a Bluetooth high priority period was detected, and PS mode is possible, the PRM performs the following steps: (1) enters Bluetooth high priority protective mode; (2) sets the “listen interval” parameter to 1 (i.e. listens to every beacon, in order to reduce the probability of missing a beacon); and (3) optionally activates the beacon protection mechanism.

If a Bluetooth high priority pattern is not detected, or a detected pattern is terminated, or PS mode cannot be entered, the PRM performs the following steps: (1) enters/remains in “common mode” operation”; (2) returns/stays in default the “listen interval”; and (3) optionally deactivates the beacon protection mechanism.

### PTA Machine

The PTA machine 22 (FIG. 11) is operative to receive the requests from the WLAN and Bluetooth systems, and in accordance with the streaming information and time constraints, manages the traffic over the link. The PTA machine operates on the fly, and makes decision for the next frame and during the current frame. The PTA allocates bandwidth according to the Bluetooth and WLAN system states, priorities and requests received therefrom. Note that the PTA operates differently whether or not Bluetooth high priority is in the background.

### PTA in Common Mode

The PTA decision is made according to the WLAN and Bluetooth priorities and requests. In the “common mode” of operation there is no need to make rate and time estimates, since future Bluetooth activity is not a factor in the decision. As a default, the antenna is allocated in favor of the WLAN system.

The processing procedure of a request submitted to the PTA when in “common mode” is described below. A flow diagram illustrating the PTA common mode method of the present invention is shown in FIG. 15. The WLAN high priority will cancel a Bluetooth low priority transaction. Since there are a small number of WLAN events that are categorized as high priority, Bluetooth performance in not impacted significantly.

First, the request is checked whether it is Bluetooth or WLAN request (step 50). If the request is a Bluetooth high priority request (step 51), the antenna is switched to the Bluetooth system (step 58). If not, if the request is a WLAN high priority request (step 52) and a Bluetooth high priority request is not active (step 60), the antenna is switched to the WLAN device (step 68).

If the request is not a high priority Bluetooth or WLAN request (steps 52, 54) then if there are no active requests (step 54), the antenna is switched to the requesting object (step 56).

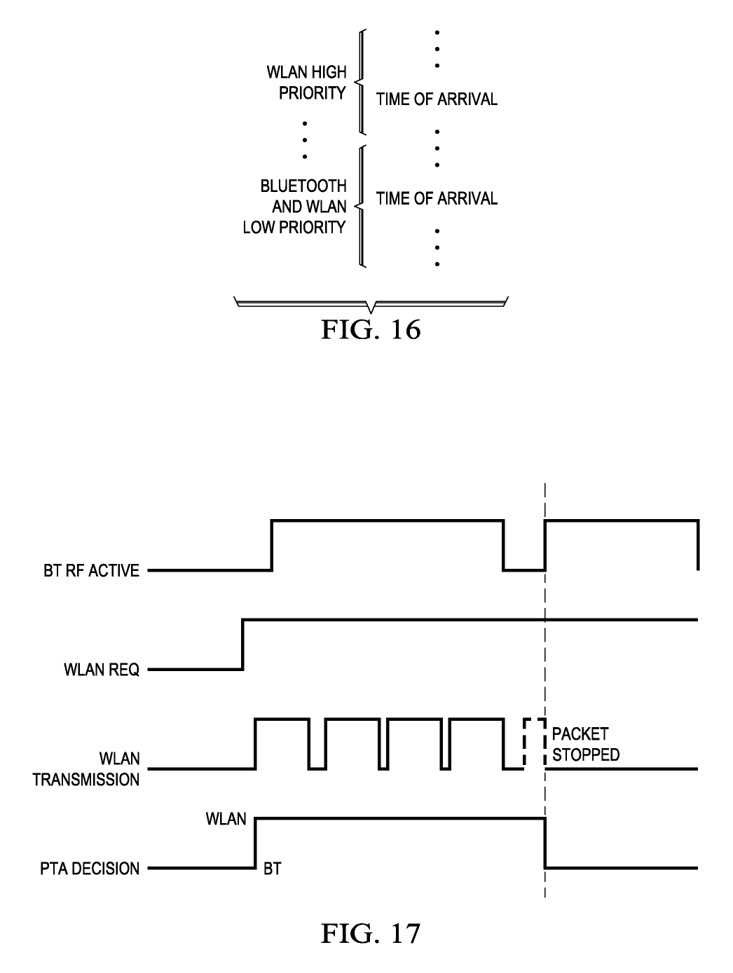

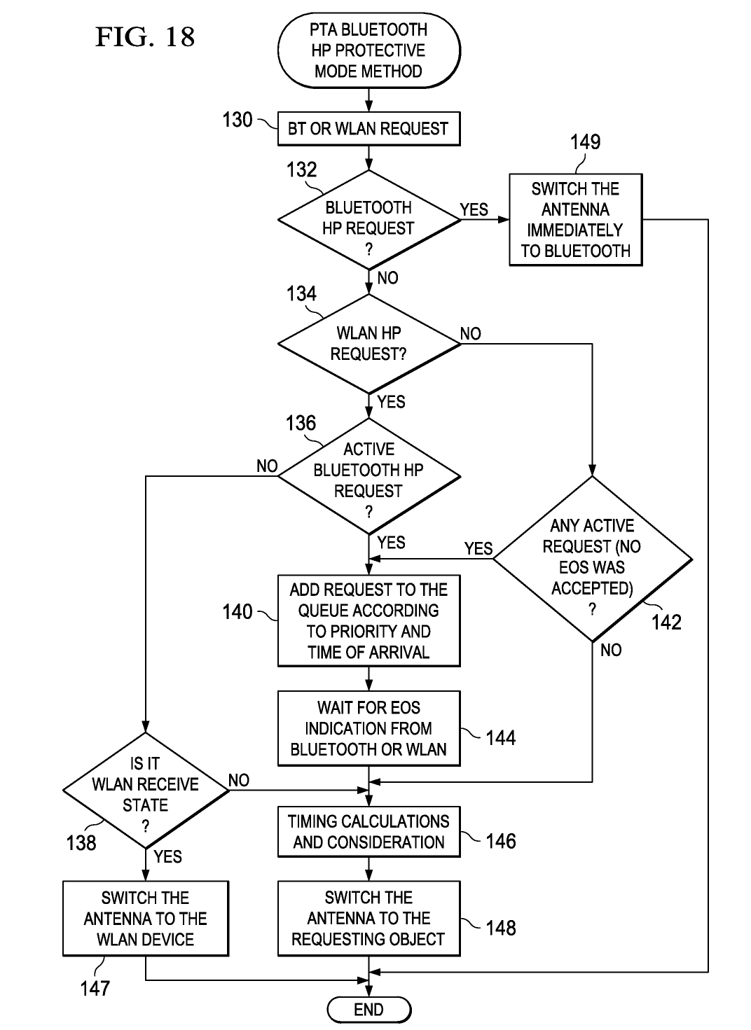

If an active request is received (step 54), the request is added to the queue according to the parameters of priority and time of arrival (step 62). The sequencing is made first based on priority (high to low: WLAN HP, Bluetooth and WLAN LP) and only as the second level on time of arrival. The method then waits for an EOS indication from the Bluetooth or WLAN systems (step 64). The antenna is then switched to the system with the first request in the queue (step 66). Bluetooth high priority gains bandwidth immediately and does not appear in the queue. A diagram illustrating the PTA queue in more detail is shown in FIG. 16.

As part of managing the queue, requests that are out of date are deleted. For example, RX for beacons that were not performed because of Bluetooth high priority may not relevant any more. A request can be returned to the queue after it was executed if the service was interrupted in the middle. For example, a WLAN high priority transaction that was cut by Bluetooth high priority will be returned to the queue.

If several requests for the same service are submitted while the same request was already active on the link, the time of arrival of the requests is the end of service (EOS) of the active service. If the requests for the service were submitted while the same request was not active, the time of arrival is the time of the first request.

For example, if several WLAN low priority TX requests are submitted while WLAN low priority transmissions are occurring over the air, the new request is added to the queue with time of arrival of the EOS of the WLAN low priority transmission only when the current transmission terminates. In the case of any other type of transmission over the air, only the first WLAN low priority TX request with its original time of arrival is added to the queue.

The WLAN transmissions can be scheduled to any desired point of time. Therefore, the WLAN transmissions are scheduled at the end of the Bluetooth transmissions. The opposite case, however, is different. The Bluetooth transmissions cannot be scheduled at the end of the WLAN transaction and a long period of time may elapse from the end of the WLAN transmission to the beginning of the next Bluetooth transmission (assuming the Bluetooth request was submitted during the WLAN TX and the WLAN ended only after the Bluetooth already began). In order to exploit this time period, the WLAN system continues transmitting (but not receiving) for as long as the Bluetooth BT_ACTIVITY signal is high (and the WLAN EOS was in the middle of the BT_ACTIVITY). In this case, the PTA immediately halts the WLAN transmission in the next assertion of the Bluetooth BT_ACTIVITY signal. The WLAN system is not permitted to RX in order to prevent AP rate fall back when the antenna is switched to the Bluetooth system. A timing diagram illustrating WLAN system timing utilzing unused Bluetooth bandwidth is shown in FIG. 17.

The WLAN system may have a burst of packets until the beginning of the next Bluetooth packet, or by using the WlanEOSMaxPacket value. The WlanEOSMaxPacket is bounded and limited by a timeout configured in the register WlanEOSMaxPacket_to. The time out is counted from the end of the last WLAN packet.

The Bluetooth system also has an opportunity to burst packets using the BtPTAMaxPacket register. This register comprises the number of Bluetooth requests, wherein only after fulfilling them all, can the PTA switch to WLAN low priority request. If BtPTAMaxPacket>1, the PTA mechanism is no longer single packet wise, but multi-packet wise. The BtPTAMaxPacket register is bounded and limited by a timeout configured in the register BtPTAMaxPacket_to. The time out is counted from the end of the last Bluetooth packet.

If a Bluetooth high priority transaction disrupted a WLAN transaction before it ended (i.e. before an EOS was accepted), the WLAN procedure starts again immediately after the termination of the Bluetooth high priority transmission and after the clear channel assessment (CCA) indicates the link is clear.

If a Bluetooth transmission intentionally disrupted a WLAN transaction as instructed by the PTA, the following actions are taken: (1) for TX, no fall back in rate occurs; and (2) for TX, the contention window (CW) value is not changed.

Note that an additional feature of the mechanism of the present invention is the capability to turn off the Bluetooth in the middle of a transaction. The decision whether to terminate the BT transmission in the middle of a transaction is based on WLAN and BT priority, and on power consumption considerations. As an example, when the WLAN is awaked for a beacon, and the BT is in low priority transmission, the algorithm shuts down the BT system and lets the WLAN receive the beacon transmission.

### PTA in Bluetooth High Priority Protective Mode

When working in Bluetooth high priority protective mode, the PTA functions to protect the Bluetooth high priority transmissions and to ensure that AP transmissions are scheduled during free Bluetooth time space, in order to prevent the AP from performing rate fall back leading up to disconnection.

The PTA decisions take into consideration timing constraints for RX procedures only. The calculation of the timing constraints is based on the PRM inputs and rate estimator. For TX procedures, the PTA ensures that the TX is not starting after a well defined time location.

### Antenna Allocation Before Entering PS Mode

The STA can be in one of three states within the process of entering PS mode: active, join or normal PS. In the active state the STA is active, but does not attempt to establish a connection. The STA requests to transmit over the antenna (i.e. transmit a beacon). In this case, the antenna is allocated on behalf of the Bluetooth system, and the WLAN system can also transmit over the antenna for its own use, as long as the Bluetooth activity is not high priority. Since the WLAN activity is minor, the Bluetooth does not suffer any performance degradation.

In the join state the STA starts the process of establishing a connection with the AP. The STA and the AP transact authentication, association and PS entering packets. Since this process is relatively short and of relative importance, the WLAN system is allocated the antenna, and the Bluetooth system gains access to the antenna it only for Bluetooth high priority traffic.

In the normal PS state the STA has already entered the PS mode. In this state, the antenna is allocated as described below. The RF antenna switch 44 (FIG. 13) comprises hardware control capability which operates such that when the WLAN system is in reset or shut down, the antenna is allocated to the Bluetooth system. This implementation ensures Bluetooth system behavior of the coexistence communications device presented below in Table 8 and WLAN system behavior of the coexistence communications device presented below in Table 9.

TABLE 8
Boundary Conditions for Bluetooth states

| | Case | | | |
|---|---|---|---|---|
| | Bluetooth system | Bluetooth system | Bluetooth system | Bluetooth system |
| WLAN state | turn on | turn off | reset | on |
| On | Coexistence | Coexistence | Coexistence | Coexistence |
| | mechanism | mechanism | mechanism | mechanism |
| Deep sleep | ANTENNA | ANTENNA | ANTENNA | ANTENNA |
| | SWITCHED TO | SWITCHED TO | SWITCHED TO | SWITCHED TO |
| | BT | BT | BT | BT |
| Off | WLAN hardware | WLAN hardware | WLAN hardware | WLAN hardware |
| | switches the | switches the | switches the | switches the |
| | antenna to the | antenna to the | antenna to the | antenna to the |
| | Bluetooth system. | Bluetooth system. | Bluetooth system. | Bluetooth system. |

TABLE 9
Boundary Conditions for WLAN states

| | Case | | | |
|---|---|---|---|---|
| Bluetooth state | WLAN turn on | WLAN turn off | WLAN reset | WLAN on |
| On | WLAN hardware | WLAN hardware | WLAN hardware | Coexistence |
| | switches the | switches the | switches the | mechanism |
| | antenna to the | antenna to the | antenna to the | |
| | Bluetooth system. | Bluetooth system. | Bluetooth system. | |
| Off | WLAN hardware | WLAN hardware | WLAN hardware | The antenna |
| | switches the | switches the | switches the | remains in WLAN |
| | antenna to the | antenna to the | antenna to the | control. |
| | Bluetooth system. | Bluetooth system. | Bluetooth system. | |

### Antenna Switching

The coexistence mechanism of the present invention is well suited for operation with single antenna use. An example of the single antenna platform is shown in and described in connection with FIG. 3. The antenna switching process is typically very short, e.g., less than 1 microsecond.

The transformation from the Bluetooth system to the WLAN system is performed by (1) asserting the Bluetooth shutdown signal and (2) via the antenna switch. After switching from Bluetooth to WLAN, a configurable time delay BTtoWLANSwitchTime is invoked in order to ensure the Bluetooth system completes its ramp down. This time delay is used only if the Bluetooth transmission was interrupted, hence the BT_ACTIVITY signal was high. If the BT_ACTIVITY signal was low, the delay is set to a fixed value of 15 microseconds.

The transformation from the WLAN system to the Bluetooth system is performed by (1) stopping all TX procedures (including PA ramp down) and entering the RX state; (2) via the antenna switch. After switching from WLAN, a 2 microsecond delay is inserted in order to allow the WLAN system to complete its ramp down. This time delay is a needed only if the WLAN TX was interrupted. Both the antenna and the Bluetooth shutdown signal are asserted and de-asserted simultaneously as a function of the value of BTtoWLANSwitchTime.

In the example coexistence system presented herein, the isolation of the RF antenna switch is approximately 30 db. A Bluetooth transmission at 0 dBm is received in the WLAN as a narrowband interferer with −30 dBm. Therefore, it is preferable to configure the Bluetooth coexistence parameters such that the Bluetooth shutdown causes an immediate ramp down in the Power Amplifier (PA), thus halting a packet in the middle of transmission. For similar reasons, it is preferable to enable the AFH feature on the Bluetooth side. After the RF antenna is switched to the Bluetooth system, the WLAN system enters the RX state, and attempts to receive, despite the 30 db degradation of the antenna switch.

### Mobile Device Incorporating the WLAN/Bluetooth High Power Transmission Scheme

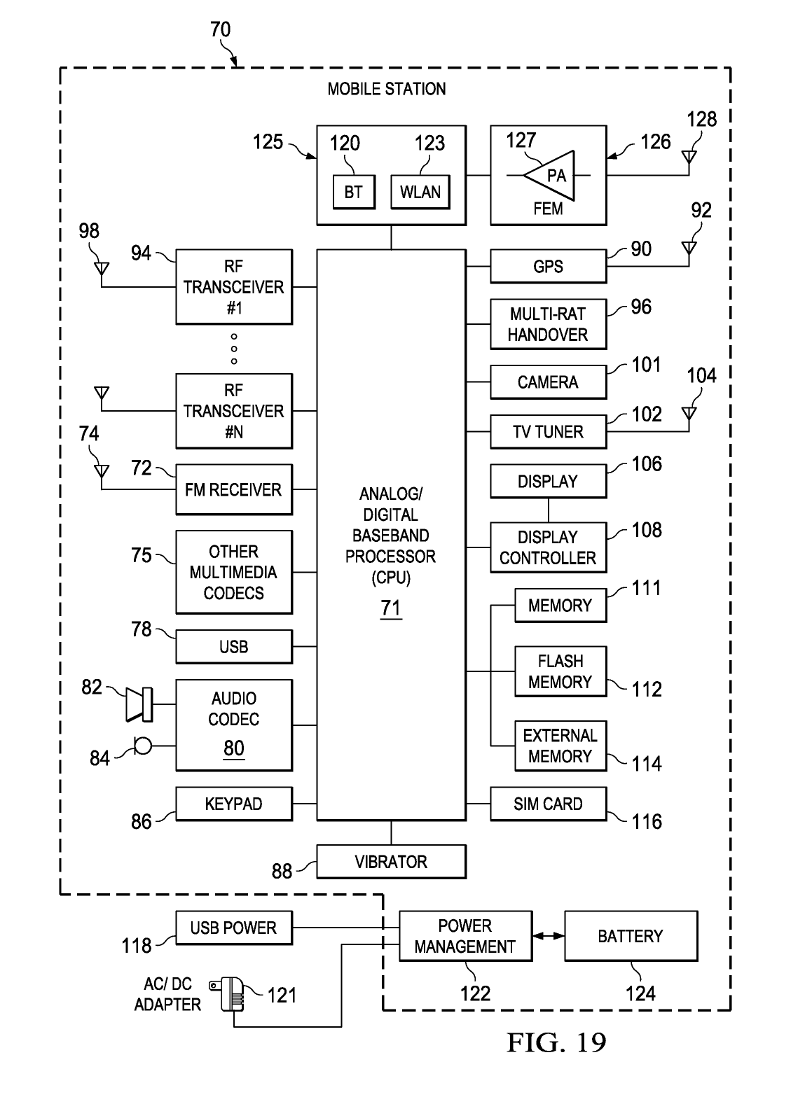

A simplified block diagram illustrating an example mobile communication device incorporating the Bluetooth/WLAN high power transmission scheme of the present invention within multiple radio transceivers is shown in FIG. 19. Note that the mobile device may comprise any suitable wired or wireless device such as multimedia player, mobile communication device, cellular phone, smartphone, PDA, Bluetooth device, etc. For illustration purposes only, the device is shown as a mobile device, such as a cellular phone. Note that this example is not intended to limit the scope of the invention as the power efficiency improvement mechanism of the present invention can be implemented in a wide variety of communication devices.

The mobile device, generally referenced 70, comprises a baseband processor or CPU 71 having analog and digital portions. The mobile device may comprise a plurality of RF transceivers 94 and associated antennas 98. RF transceivers for the basic cellular link and any number of other wireless standards and Radio Access Technologies (RATs) may be included. Examples include, but are not limited to, Global System for Mobile Communication (GSM)/GPRS/EDGE 3G; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; UWB; etc. One or more of the RF transceivers may comprise additional antennas to provide antenna diversity which yields improved radio performance. The mobile device may also comprise internal RAM and ROM memory 110, Flash memory 112 and external memory 114.

The mobile device comprises a WLAN/Bluetooth radio module 125 having a WLAN core 123 and a Bluetooth core 120. The radio module 125 is coupled to the front end module (FEM) 126 which comprises a power amplifier 127 for amplifying a TX input signal for transmission over external antenna 128. In accordance with the invention, the power amplifier 127 in the FEM is configured to be shared between the WLAN and Bluetooth cores as described in more detail supra.

Several user-interface devices include microphone(s) 84, speaker(s) 82 and associated audio codec 80 or other multimedia codecs 75, a keypad for entering dialing digits 86 and for other controls and inputs, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM transceiver 72 and antenna 74 provide the user the ability to listen to FM broadcasts as well as the ability to transmit audio over an unused FM station at low power, such as for playback over a car or home stereo system having an FM receiver. SIM card 116 provides the interface to a user's SIM card for storing user data such as address book entries, user identification, etc.

Portable power is provided by the battery 124 coupled to power management circuitry 122. External power may be provided via USB power 118 or an AC/DC adapter 121 connected to the battery management circuitry 122, which is operative to manage the charging and discharging of the battery 124.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A radio frequency (RF) front end module (FEM) for use with a first radio and a second radio, comprising:
a power amplifier operative to amplify a transmit signal for transmission over an external antenna; and
interface circuitry operative to electrically couple the transmit signal from either a first radio or a second radio to the input of said power amplifier such that said power amplifier is shared between said first radio and said second radio.

2. The front end module according to claim 1, wherein said power amplifier comprises a Bluetooth class 1 power amplifier.

3. The front end module according to claim 1, wherein said interface circuitry comprises a first switch operative to couple the input of said power amplifier to the transmit signal output of either said first radio or said second radio, in accordance with a first control signal.

4. The front end module according to claim 1, wherein said interface circuitry comprises a second switch operative to couple said antenna to the receive input of either said first radio or said second radio, in accordance with a second control signal.

5. The front end module according to claim 1, wherein said first radio comprises a wireless local area network (WLAN) radio.

6. The front end module according to claim 1, wherein said second radio comprises a Bluetooth radio.

7. A radio frequency (RF) front end module (FEM) for use with a wireless local area network (WLAN) radio and a Bluetooth radio, comprising:
a power amplifier having an input and an output, said power amplifier adapted to be shared by said WLAN radio and said Bluetooth radio;
a first switch operative to electrically couple the transmit signal output of either said WLAN radio or said Bluetooth radio to the input of said power amplifier in accordance with a first switch control signal; and
coupling circuitry operative to electrically couple the output of said power amplifier to an antenna.

8. The front end module according to claim 7, wherein said coupling circuitry comprises a second switch operative to electrically couple the antenna, in accordance with a second switch control signal, to either the receiver of said WLAN radio, the receiver of said Bluetooth radio or the output of said power amplifier.

9. The front end module according to claim 7, wherein said power amplifier comprises a Bluetooth class 1 power amplifier.

10. The front end module according to claim 7, further comprising switching means for bypassing said power amplifier for Bluetooth non-class 1 power transmission.

11. The front end module according to claim 7, wherein said first switch and said WLAN radio are co-located in the same chip.

12. The front end module according to claim 7, wherein said power amplifier and said first switch are controlled by a WLAN core incorporating said WLAN radio.

13. A high power radio frequency (RF) transmission system, comprising:
an RF front end module (FEM), comprising:
a power amplifier operative to amplify a TX input signal for transmission over an external antenna, said power amplifier adapted to be shared by a plurality of radios;
a radio module, comprising:
a first radio core comprising a first transmit path operative to be electrically coupled to the TX input of said FEM;
a second radio core comprising a second transmit path; and
a first switch operative to electrically couple said second transmit path to said first transmit path in accordance with a control signal, thereby electrically coupling said second transmit path to the TX input of said FEM; and
wherein said first radio core and said second radio core share access to said power amplifier within said FEM.

14. The method according to claim 13, wherein said FEM comprises a second switch operative to couple said antenna to the RX input of either said first radio core or said second radio core.

15. The method according to claim 13, wherein said first radio core comprises a wireless local area network (WLAN) core.

16. The method according to claim 13, wherein said second radio core comprises a Bluetooth core.

17. The method according to claim 13, wherein said power amplifier comprises a Bluetooth class 1 power amplifier.

18. The method according to claim 13, wherein said FEM, said first radio core and said second radio core are controlled via a plurality of control signals generated by said radio module.

19. The method according to claim 13, wherein said first switch is operative to electrically couple either said first transmit path or second transmit path to the TX input of said FEM at any point in time.

20. A method of high power wireless local area network (WLAN) and Bluetooth transmission, said method comprising the steps of:
providing a front end module (FEM) comprising a single power amplifier;
providing a first TX path from a WLAN core to said power amplifier;
providing a second TX path from a Bluetooth core to said power amplifier;
first switching between said first TX path and said second TX path, in accordance with a first control signal, such that said power amplifier is shared by said WLAN core and said Bluetooth core; and
coupling the output of said power amplifier to an external antenna.

21. The method according to claim 20, wherein said WLAN core and said Bluetooth core are integrated in a radio module.

22. The method according to claim 21, wherein said switching occurs in said radio module.

23. The method according to claim 20, wherein said switching occurs in said FEM.

24. The method according to claim 20, wherein said power amplifier comprises a Bluetooth class 1 power amplifier.

25. The method according to claim 20, further comprising the step of bypassing said power amplifier for Bluetooth non-class 1 power transmission.

26. The method according to claim 20, further comprising the step of second switching said external antenna to either a first RX path to said WLAN core or to a second RX path to said Bluetooth core, in accordance with a second control signal.

27. A communications device, comprising:
a wireless local area network (WLAN) radio;
a Bluetooth radio;
a front end module, comprising;
a power amplifier operative to amplify a transmit signal for transmission over an external antenna coupled to said FEM; and
coupling circuitry operative to electrically couple the transmit signal from either said WLAN radio or said Bluetooth radio to the input of said power amplifier such that said power amplifier is shared between said WLAN radio and said Bluetooth radio.

28. The device according to claim 27, wherein said power amplifier comprises a Bluetooth class 1 power amplifier.

29. The device according to claim 27, wherein said coupling circuitry comprises a first switch operative to couple, in accordance with a first control signal, the input of said power amplifier to the transmit signal output of either said WLAN radio or said Bluetooth radio.

30. The device according to claim 27, wherein said coupling circuitry comprises a second switch operative to electrically couple the external antenna, in accordance with a second switch control signal, to either a receiver of said WLAN radio, a receiver of said Bluetooth radio or the output of said power amplifier.
